(19) United States
(12) Patent Application Publication
(10) Pub. No.: US 2007/0171811 A1
(43) Pub. Date: Jul. 26, 2007

(54) Apparatus for effectively transmitting in orthogonal frequency division multiple access using multiple antenna and method thereof

(75) Inventors: Yu-Ro Lee, Daejeon-city (KR); Dong-Seung Kwon, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: Samsung Electronics Co., Ltd., Suwon-si (KR); Electronics and Telecommunications Research Institute, Daejeon (KR); KT Corporation, Seongnam-city (KR); SK TELECOM CO., LTD, Seoul (KR); HANARO TELECOM., INC., Seoul (KR)

(21) Appl. No.: 11/585,481

(22) Filed: Oct. 24, 2006

(30) Foreign Application Priority Data
Oct. 24, 2005 (KR) 10-2005-0100176

(51) Int. Cl. H04J 11/00; H04Q 7/00

(52) U.S. Cl. 370/208; 370/334

(57) ABSTRACT

The present invention relates to a transmitting apparatus of an OFDMA system and a method thereof. The transmitting apparatus includes an encoder for modulating data to be transmitted into data or a preamble by using a desired modulation scheme; an S/P converter for converting serial data output from the encoder to parallel data; a preamble or pilot generator for generating a pilot or preamble; a multiplexer for multiplexing the data or preamble output from the preamble or pilot generator and the parallel data; an antenna selection controller for dividing an entire band of a signal output from the multiplexer into groups formed of neighboring symbols in time domain and neighboring subcarriers in frequency domain, and selecting a transmit antenna for each group; an IFFT unit for turning off subcarriers in groups selected by the antenna selection controller and subcarriers in unselected groups by the antenna selection controller and performing IFFT; for each antenna, a P/S converter for converting parallel signals transmitted from the IFFT unit into serial signals and inserting a cyclic prefix; and for each antenna, a D/A converter and filter for converting a digital signal transmitted from the P/S into an analog signal and filtering the analog signal, and transmitting the filtered analog signal through an antenna of an R/F end. Accordingly, when a transmitting end does not know a channel state of a transmit antenna, a transmit antenna is selected for an allocation unit and data is transmitted through the selected transmit antenna when a transmitting end of an OFDMA system using multiple antennas does not know a channel state, and accordingly a diversity gain can be acquired without making any changes in allocation of subcarriers according to the number of antennas, a transmission structure of a pilot of the transmitting end, an allocation structure of the transmitting end, and a receiving end. In addition, when the transmitting end does know the channel state, an antenna having the best channel state is selected for each group, and accordingly, performance degradation due to feedback delay of channel state information and inter-antenna interference due to an increase of mobility of the terminal can be prevented.

### BACKGROUND OF THE INVENTION

(a) Field of the Invention

The present invention relates to a transmitting apparatus of an orthogonal frequency division multiplex (OFDM) system using multiple antennas, and a method thereof. More particularly, the present invention relates to a transmitting apparatus of an OFDM system using multiple antennas for obtaining a diversity gain without changing subcarrier allocation and. pilot transmission processes according to the number of antennas, and reducing performance degradation due to inter-antenna interference that results from a channel state information feedback delay and an increased mobility of a terminal.

(b) Description of the Related Art

In general, an orthogonal frequency division multiplexing (OFDM) technique is used for wideband high-speed data transmission. In OFDM, an available bandwidth is divided into a plurality of subcarriers.

FIG. 1 shows a basic block diagram of a conventional OFDM-based system.

As shown in FIG. 1, a transmitting apparatus of the conventional OFDM-based system includes a QAM encoder 11, a serial-to-parallel (S/P) converter 12, a multiplexer 13, a preamble or pilot generator 14, an inverse fast Fourier transform (IFFT) unit 15, a parallel to serial (P/S) converter 16, a digital to analogue (D/A) converter and filter 17, and an antenna (ANT) of a radio frequency terminal.

The QAM encoder 11 receives data to be transmitted and modulates data or a preamble by using a desired modulation method (e.g., BPSK, QPSK, 16 QAM, and 64 QAM).

The S/P converter 12 converts serially received high-speed data into parallel low-speed data.

The multiplexer 13 multiplexes the preamble or data and the parallel data.

The preamble or pilot generator 14 generates a pilot and a preamble.

The IFFT unit 15 performs inverse FFT on a multiplexed signal to convert the multiplexed signal into a time-axis signal, and the P/S converter 16 converts a parallel signal output from the IFFT unit 15 into a serial signal and inserts a cyclic prefix (CP) to the beginning of the serial signal.

The D/A converter and filter 17 converts a digital signal into an analog signal and processes the analog signal through a filter, and then transmits the filtered analog signal through the ANT of the RF terminal.

A receiving apparatus of the OFDM-based system includes an antenna (ANT) of an RF terminal, an A/D converter and filter 20, an S/P converter 21, an FFT unit 22, a demultiplexer 23, a preamble and pilot generator 24, a P/S converter 25, and a QAM decoder 26.

The A/D converter and filter 20 processes the analog signal received through the ANT of the RF terminal in the receiving apparatus and converts the filtered analog signal into a digital signal.

The S/P converter 21 removes the CP from the digital signal and converts the signal into a parallel signal.

The FFT unit 22 performs fast Fourier transform (FFT) on the parallel signal.

The demultiplexer 23 demultiplexes a preamble or data and a pilot signal 24 after performing the FFT.

The P/S converter 25 converts the parallel data signal demultiplexed by the demultiplexer 23 into a serial data signal.

The QAM decoder 26 demodulates QAM data by using a channel estimate value estimated by the preamble or pilot and generates receiving data.

When channel state information of the transmitting apparatus is not known, space time block code (STBC), space frequency block code (SFBC), and delay diversity are used to improve performance so as to obtain channel diversity. When the channel state information is known by receiving feedback from a receiving end or using channel reciprocity (i.e., TDD) of a transmitting/receiving end, a transmitting end improves performance by transmitting data by using a channel weight.

A prior-art will be described in two cases; in the case that a transmitting end knows channel state information and in the case that the transmitting end does not know the channel state information.

(1) In the case that the transmitting end does not know channel state information

The transmitting end uses STBC or SFBC to maximize a transmit diversity. However, such a scheme requires pilots to specify antennas, and accordingly channel estimation performance may be reduced compared to the case of using a single antenna. That is, performance can be improved when a terminal ideally knows a channel state from each antenna, but the performance may be degraded when a channel state is estimated from a transmission pilot. In addition, modification of a pilot allocation structure is required to specify each antenna according to the number of antennas, and complexity of the transmitting end and the receiving end may be increased since the transmitting end and the receiving end require encoders and decoders for the STBC and SFBC, respectively.

When delay diversity is used, modification of the pilot allocation structure and modification of the receiving end according to the number of antennas are not required. The delay diversity performs a cyclic shift on a symbol in which a cyclic prefix is added for each antenna by the number of predetermined samples, and transmits the cyclically shifted symbol. Such a delay diversity method does not require a pilot for estimating a channel for each antenna and obtains diversity when a correlation of multiple antennas at the receiving end is low. However, when the correlation of the antennas is high, degradation of performance may be caused due to inter-antenna interference. A correlation of antennas may vary depending on distance between transmit antennas, structure of the transmit antenna, and wireless channel environment.

FIG. 2 shows a result of comparing ideal channel estimation and real channel estimation in the case of using an STBC and delay diversity. As shown in FIG. 2, when the transmitting end ideally knows a channel, performance of the STBC is superior to that of the delay diversity, but when a channel is estimated by using a pilot, the performance of the STBC becomes similar to that of the delay diversity.

FIG. 3 shows the number of transmit antennas and performance of the delay diversity scheme according to a correlation between antennas when a correlation between antennas exists.

(2) In the case that the transmitting end knows channel state information

When the transmitting end knows channel state information, the transmitting end may use a channel weight and therefore performance can be improved when a feedback delay is small and the mobile speed of the terminal is low. However, in a real mobile communication system, the terminal may move at high-speed and a feedback delay may be generated depending on a transmission frame structure. When such a delay is generated, a channel state can be changed, and accordingly a system using a channel weight for transmission may experience significant performance degradation.

### SUMMARY OF THE INVENTION

The present invention has been made in an effort to provide a transmitting apparatus having advantages of acquiring a diversity gain without making any changes in allocation of subcarriers according to the number of antennas, a transmission structure of a pilot of the transmitting end, an allocation structure of the transmitting end, and a receiving end when a transmitting end does not know a channel state of a transmit antenna, and preventing performance degradation due to feedback delay of channel state information and inter-antenna interference due to increase of mobility of the terminal when the transmitting end does know the channel state, in an OFDMA system, and a method thereof.

A transmitting apparatus according to an embodiment of the present invention is provided to an OFDMA system using multiple antennas. The transmitting apparatus includes an encoder, an S/P converter, a preamble or pilot generator, a multiplexer, an antenna selection controller, an IFFT unit, a P/S converter, and a D/A converter and filter. The encoder receives data and modulates data or a preamble according to a desired modulation scheme. The S/P converter converts serial data output from the encoder to parallel data. The preamble or pilot generator generates a pilot or preamble;

The multiplexer multiplexes the data or preamble output from the preamble or pilot generator and the parallel data;

The antenna selection controller divides an entire band of a signal output from the multiplexer into groups formed of neighboring symbols in time domain and neighboring subcarriers in frequency domain, and selects a transmit antenna for each group. The IFFT unit turns off subcarriers in groups selected by the antenna selection controller and subcarriers in unselected groups by the antenna selection controller and performs IFFT. For each antenna, the P/S converter converts parallel signals transmitted from the IFFT unit into serial signals and inserts a cyclic prefix. For each antenna, the D/A converter and filter converts a digital signal transmitted from the P/S converter into an analog signal and filters the analog signal, and transmits the filtered analog signal through an antenna of an R/F end.

A transmission method according to another embodiment of the present invention is provided to an OFDMA system using multiple antennas. The transmission method includes (a) receiving data and modulating data or a preamble by using a desired modulation method; (b) converting serially received modulated data into parallel data; (c) generating a preamble and a pilot; (d) multiplexing the preamble or pilot and the parallel data; (e) dividing an entire band into groups formed of neighboring symbols in time domain and neighboring subcarriers in frequency domain, and selecting a transmit antenna for each group; (f) turning off subcarriers in groups selected by an antenna selection controller and subcarriers in groups unselected by the antenna selection controller and performing IFFT; (g) for each transmit antenna, converting a parallel signal transmitted from an IFFT unit into a serial signal and inserting a cyclic prefix to the signal; and (h) for each transmit antenna, converting and filtering a digital serial signal into an analog signal, and transmitting the analog signal through an antenna of an RF end.

### BRIEF DESCRIPTION OF THE DRAWINGS

FIG. 1 shows a basic block diagram of a conventional OFDM.

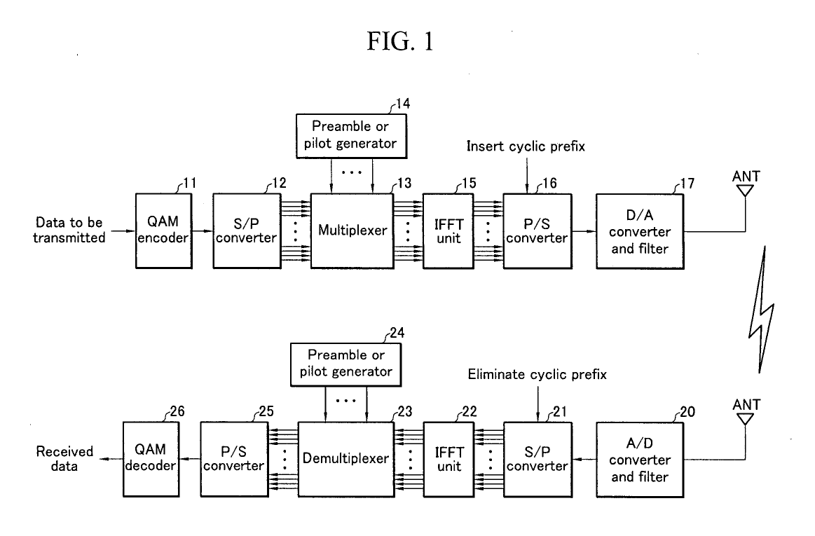

FIG. 2 shows a result of comparison between performance of an STBC and performance of a delay diversity scheme in ideal channel estimation and real channel estimation.

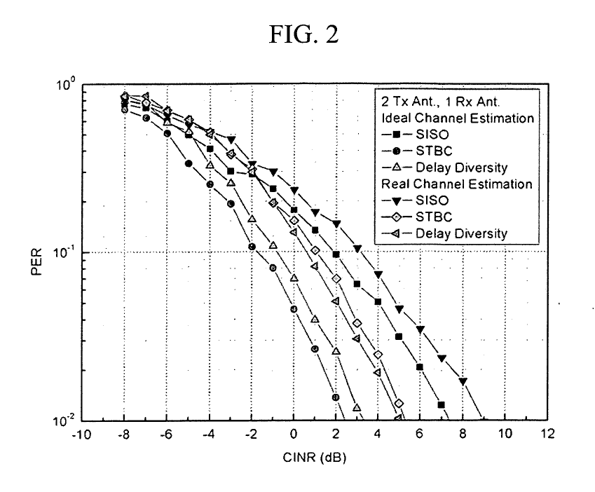

FIG. 3 shows the number of transmit antennas and performance of the delay diversity scheme when a correlation between antennas exists.

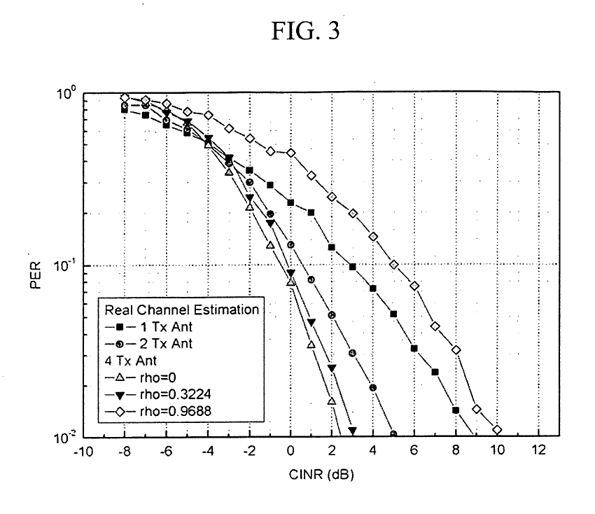

FIG. 4 shows comparison between the delay diversity scheme and a proposed scheme according to the embodiment of the present invention when a correlation between antenna spacing exists.

FIG. 5 shows comparison of a group formed of neighboring symbols and a group formed of neighboring subcarriers according to the exemplary embodiment of the present invention.

FIG. 6 shows a structure of a symbol domain and a frequency domain formed by groups and an allocated group definition (n,k).

FIG. 7 is a block diagram of a transmitting end according to the exemplary embodiment of the present invention.

FIG. 8 is a flowchart of an efficient transmission process in an OFDMA system using multiple antennas according to the exemplary embodiment of the present invention.

FIG. 9 shows an allocation diagram in the case that a transmit antenna of the (n,k)-th group is determined by k mod M.

FIG. 10 shows a structure of a frequency selection controller in the case that the transmit antenna of the (n,k)-th group is determined by k mod M.

FIG. 11 shows an allocation diagram in the case that the transmit antenna of the (n,k)-th group is determined by (k+n) mod M.

FIG. 12 shows an allocation diagram in the case that the transmit antenna of the (n,k′)-th group is determined by (k′+n) mod M.

FIG. 13 exemplarily shows channel power of each transmit antenna.

FIG. 14 shows a structure of an antenna selection controller in the case of using a channel weight when a transmitting end knows a channel state.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” or variations such as “comprises” or “comprising” will be understood to imply the inclusion of stated elements but not the exclusion of any other elements.

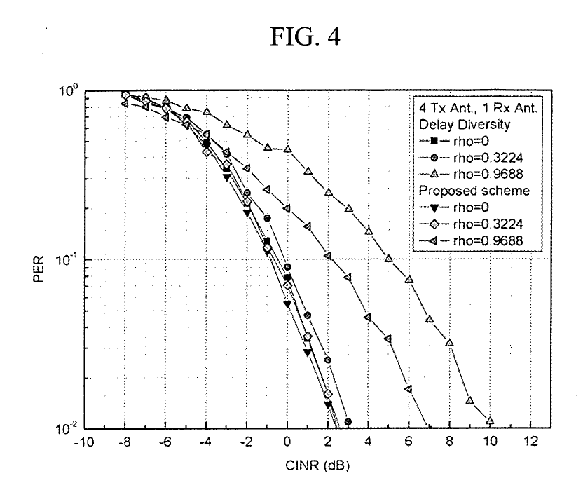

According to an exemplary embodiment of the present invention, when a transmitting end of an OFDMA system using multiple antennas does not know a channel state, data is transmitted by alternately selecting an antenna from among the multiple antennas per allocation unit, and therefore a diversity gain can be obtained without changing allocation of subcarriers according to the number of antennas, pilot transmission, and allocation structures of the transmitting end and a receiving end. FIG. 4 shows a result of comparison between performance of a delay diversity scheme and performance of a proposed scheme according to an exemplary embodiment of the present invention in the case that correlation exists between antennas.

In addition, according to the exemplary embodiment of the present invention, when the transmitting end does know the channel state information of each transmit antenna, an antenna having the best channel state is selected for each group to thereby avoid performance degradation due to a feedback delay of channel state information and inter-antenna interference (IAI) resulting from increase of mobility of a terminal.

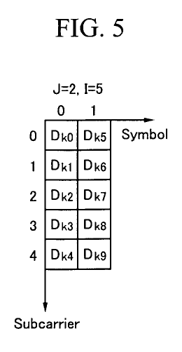

FIG. 5 shows comparison of groups, each formed of neighboring symbols and neighboring subcarriers according to the exemplary embodiment of the present invention.

As shown in FIG. 5, a basic allocation unit used in a subcarrier allocation method is formed of J neighboring symbols in time domain and I neighboring subcarriers in frequency domain according to the exemplary embodiment of the present invention. The basic allocation unit is called a group in the exemplary embodiment of the present invention. In FIG. 5, J=2 and I=5. Such a subcarrier allocation method is applied to an IEEE 802.16 orthogonal frequency division multiple access (OFDMA) system. In FIG. 5, D_{kg} denotes the g-th data symbol or pilot of the k-th group.

An entire band is formed of P groups, K groups among P groups may be allocated to a random terminal or a random sector in the case of a downlink, and subcarriers in a group may be applied to a single terminal or a plurality of terminals in the case of a downlink.

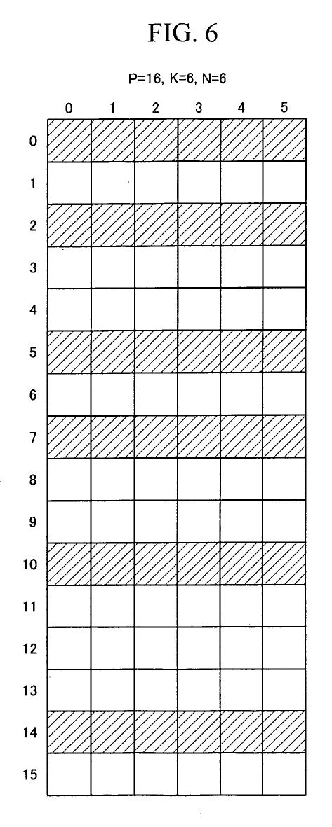

FIG. 6 shows a structure of symbol and frequency domains formed of groups and a definition of an allocated group (n,k).

FIG. 6 shows an example of such an allocation scheme. In this example, P=16, and the number of groups allocated to a terminal in the subcarrier domain is denoted as K and in the symbol domain is denoted as N, and K=6 and N=6. When it is given that n=3 and k=4, notation of the corresponding group can be represented as (3,4).

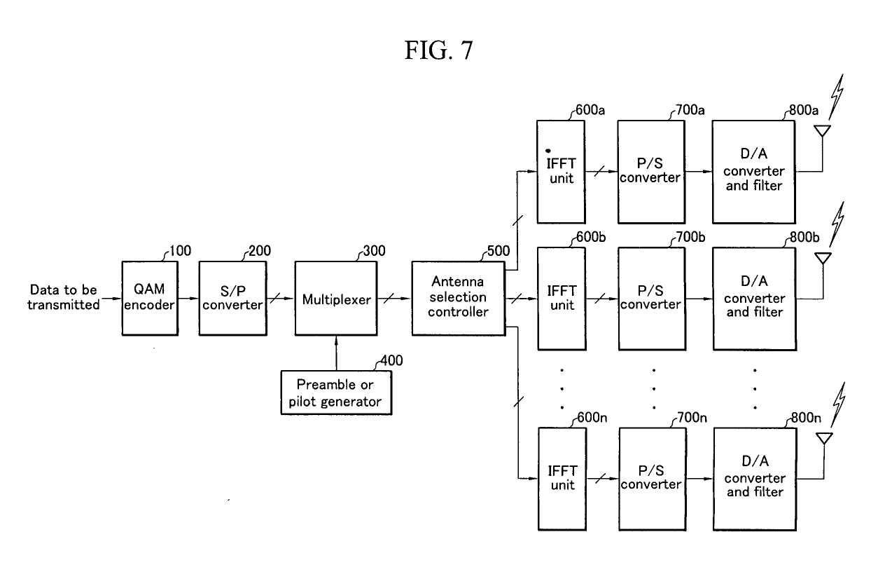

FIG. 7 is a block diagram of a transmitting end according to the exemplary embodiment of the present invention.

In the transmitting end of FIG. 7, a transmit antenna is selected for each group by an antenna selection controller.

As shown in FIG. 7, the transmitting end uses an antenna selection controller to select a transmit antenna for each group, and includes a QAM encoder 100, an S/P converter 200, a preamble or pilot generator 300, a multiplexer 400, an antenna selection controller 500, a plurality of IFFT units 600a to 600n, a plurality of P/S converters 700a to 700n, a plurality of D/A converters and filters 800a to 800n, and an antenna (ANT) of a RF end. Herein, the plurality of IFFT units, the plurality of P/S converters, and the plurality of D/A converters and filters are provided to each group.

The QAM encoder 100 receives data to be transmitted and modulates data or a preamble by using a desired modulation method (e.g., BPSK, QPSK, 16 QAM, and 64 QAM).

The S/P 200 converts high-speed serial data received from the QAM encoder 100 into low-speed parallel data.

The preamble or pilot generator 400 generates a pilot and a preamble.

The multiplexer 300 multiplexes the preamble or pilot output from the preamble or pilot generator 400 with the low-speed parallel data.

The antenna selection controller 500 divides an entire band of the signal output from the multiplexer 300 into groups, each formed of neighboring symbols in time domain and neighboring subcarriers in frequency domain, and selects a transmit antenna for each group.

The IFFT units 600a to 600n turn off (i.e. transmits 0) subcarriers of groups that are selected by the antenna selection controller 500 and subcarriers of groups that are not selected by the antenna selection controller 500 for each antenna, and performs IFFT.

The P/Ss 700a to 700n convert the parallel signals transformed by the IFFT units 600a to 600n into serial signals, and insert a cyclic prefix to the beginning of each serial signal.

The D/A converters and filters 800a to 800n convert the digital signal transmitted from- the P/Ss 700a to 700n into an analog signal and filter the analog signal, and transmit the filtered analog signal through the antenna of the RF end.

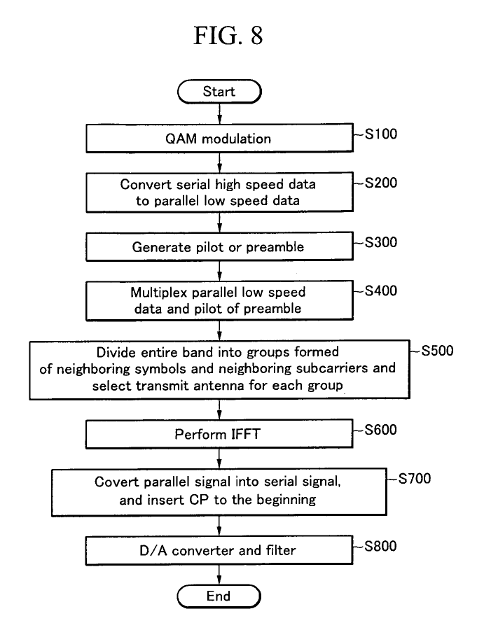

FIG. 8 is a flowchart of an efficient transmission process of an OFDMA system using multiple antennas according to the exemplary embodiment of the present invention.

The QAM encoder 100 receives data to be transmitted and modulates data or a preamble by using a desired QAM method, in step S100.

A received high-speed serial signal is converted into a low-speed parallel signal, in step S200.

A pilot and a preamble are generated in step S300, and the preamble or the low-speed parallel data and the pilot are multiplexed, in step S400.

An entire band is divided into groups, each formed of neighboring symbols in the time domain and neighboring subcarriers in the frequency domain, and a transmit antenna for each group is selected, in step S500.

For each antenna, subcarriers of a group selected by the antenna selection controller 500 and subcarriers of a group unselected by the antenna selection controller 500 are turned off (i.e. transmit 0) and inverse fast Fourier transformed, in step S600.

For each antenna, the parallel signal transmitted from the IFFT is converted into a serial signal, and a CP is inserted to the beginning of the serial signal, in step S700.

For each antenna, the digital signal transmitted from the P/S converter is converted into an analog signal and filtered, and transmitted through the antenna of the RF end, in step S800.

The antenna selection controller 500 in step S500 will be described in more detail in two cases in such an allocation structure. One is the case that the transmitting end does not know a channel state and the other is the case that the transmitting end does know a channel state.

(1) In the case that the transmitting end does not know a channel state

(1-a) A method for alternately transmitting data through a transmit antenna for each group in the frequency domain

When the channel state is not known, the antenna selection controller 500 selects a transmit antenna for transmitting the k-th group among n groups allocated to a terminal or to a given sector in the case of a downlink, and transmits the k-th group among the n groups, that is, the (n,k)-th group through the selected antenna. Herein, the transmit antenna for transmitting the (n,k)-th group is selected by using k mod M, and n denotes the number of groups to be transmitted in the frequency domain. Accordingly, the n groups can be alternately transmitted through a transmit antenna in the frequency domain.

An antenna transmitting the (n,k)-th group=k mod M

Where n denotes the number of groups in the symbol domain, k denotes the k-th group, and M denotes the number of transmit antennas.

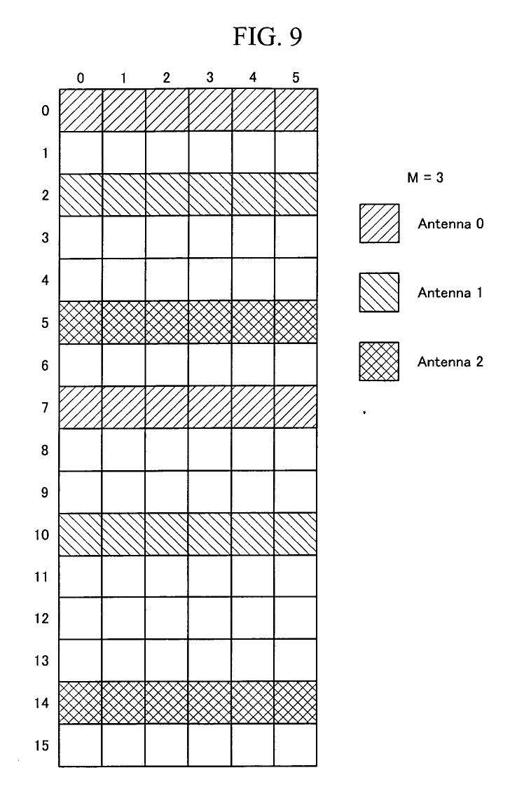

FIG. 9 shows an allocation diagram in the case that a transmit antenna for the (n,k)-th group is determined by k mod M. In this case, the number of transmit antennas M=3.

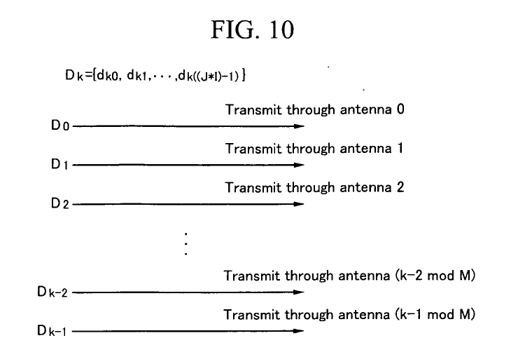

FIG. 10 shows a structure of an antenna selection controller in the case of determining the transmit antenna for the (n,k)-th group by using k mod M.

When the channel state is not known, the antenna selection controller 500 divides the entire band into groups formed of 6 neighboring symbols in the time domain and 16 neighboring subcarriers in the frequency domain, and sequentially selects a transmit antenna by using k mod M and transmits an allocated group through the selected transmit antenna.

That is, the antenna selection controller 500 determines a transmit antenna for the (n,k)-th group by using k mod M according to Dₖ={dₖ₀, dₖ₁, . . . , d_{k((J*1)-1)}}, and alternately transmits allocated groups in the frequency domain through the selected transmit antenna.

(1-b) In the case in which a specific subcarrier allocation method is extended to the symbol domain to obtain transmit diversity, independent of a specific subcarrier allocation scheme,

it is given that an antenna transmitting the (n,k)-th group =(k+n) mod M.

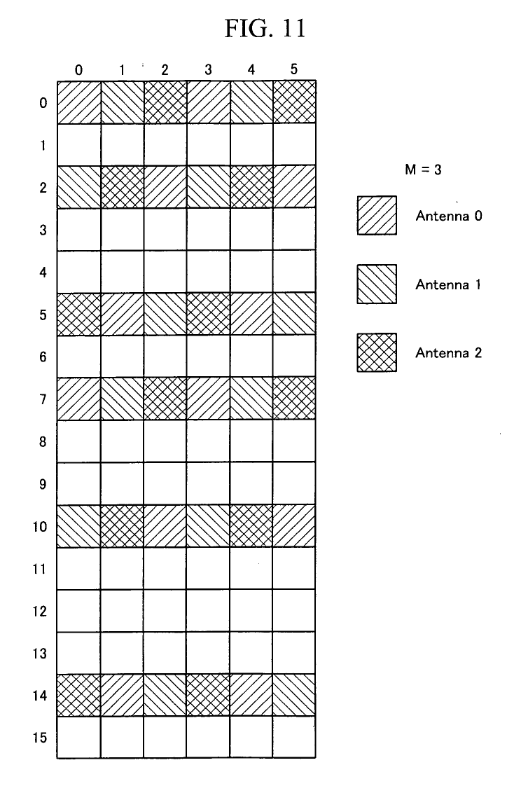

FIG. 11 shows an allocation diagram in the case of determining a transmit antenna for the (n,k)-th group by using (k+n) mod M. In FIG. 10, M=3.

(1-c) In the case of performing cyclic rotation on K allocated groups among P groups to obtain a frequency diversity in addition to the transmit diversity,

K′=(k+n) mod P.

An antenna transmitting the (n, k′)-th group=(k′+n) mod M,

where k′denotes a number of a group in which k is moved by n.

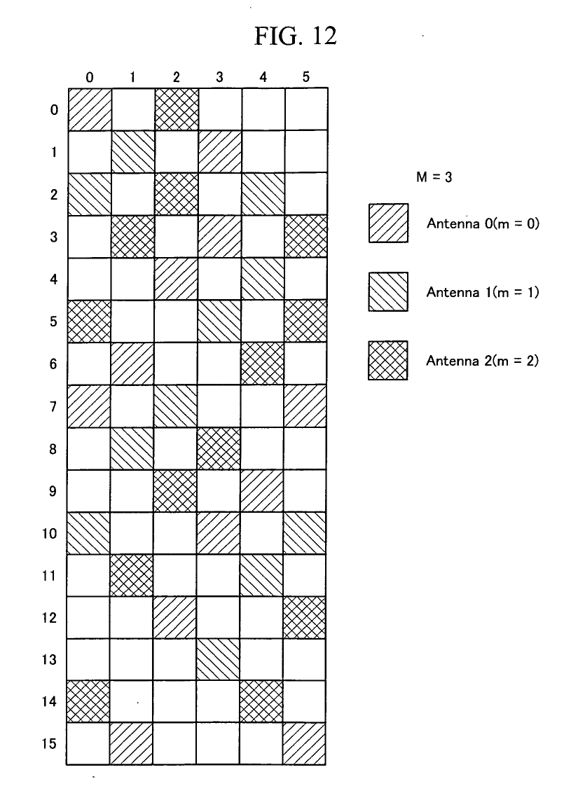

FIG. 12 shows an allocation diagram in the case of determining a transmit antenna for the (n,k′)-th group by using (k′+n) mod M. In FIG. 12, M=3.

In order to reduce a frequency diversity gain due to correlation between neighboring groups, n may be replaced with an offset value set for n.

K′=(k+bₙ) mod P can be applied,

where bₙ denotes an offset for moving the k-th group among n.

Therefore, an antenna transmitting the (n,k′)-th group=(k′+n) mod M.

In FIG. 12, bₙ=n.

2) In the case that the channel state is known

2-a) A method, for transmitting groups by selecting an antenna having the best channel state among multiple transmit antennas.

When the channel state is known by using channel feedback or channel reciprocity, the antenna selection controller 500 selects an antenna

$$( \vert {h}_{k}^{{a}_{k}} \vert = max ( \vert {h}_{k}^{0} \vert , \vert {h}_{k}^{1} \vert , … , \vert {h}_{k}^{M - 1} \vert )$$

aₖ having the maximum channel power among transmit antennas for the k-th group of the transmitting end and transmits groups through the selected transmit antenna without a channel weight such that severe performance degradation due to high-speed mobility and channel feedback delay can be prevented.

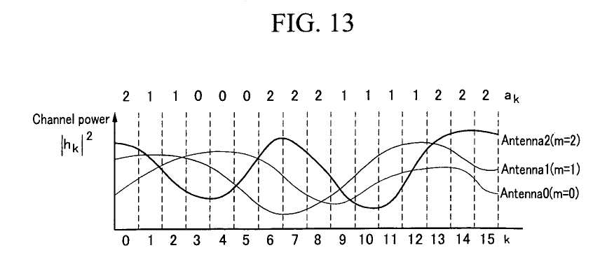

FIG. 13 exemplarily shows channel power of each transmit antenna when M=3, and aₖ in FIG. 13 denotes a number of an antenna having the best channel state in each group.

2-b) A method using a channel weight

In order to guarantee performance in a low-speed environment, a channel weight is calculated from an average power of a sum of channel power

$${\vert {h}_{k}^{{a}_{k}} \vert}^{2}$$

of an antenna having the best channel state for each group, and then transmission is performed. Herein, aₖ denotes a number of an antenna having the best channel state in the k-th group, and corresponds to one of 0, 1, 2, and M−1.

$${\vert {h}_{k}^{{a}_{k}} \vert}^{2} = max ( {\vert {h}_{k}^{0} \vert}^{2} , {\vert {h}_{k}^{1} \vert}^{2} , … , {\vert {h}_{k}^{M - 1} \vert}^{2} ) \qquad [ Equation 1 ]$$

A sum of channel power of an antenna having the best channel state for each group can be represented as given in Equation 2.

$${\vert h \vert}^{2} = \frac{1}{K} {\sum }_{k = 0}^{K - 1} {\vert {h}_{k}^{{a}_{k}} \vert}^{2} , {\vert h \vert}^{2} = \frac{1}{K} {\sum }_{k = 0}^{K - 1} ( {h}_{k}^{{a}_{k}} * {( {h}_{k}^{{a}_{k}} )}^{*} ) \qquad [ Equation 2 ]$$

A channel weight of a signal transmitted through an aₖ-th antenna selected for each group can be represented as given in Equation 3.

$${w}_{k}^{{a}_{k}} = \frac{{( {h}_{k}^{{a}_{k}} )}^{*}}{\vert h \vert} \qquad [ Equation 3 ]$$

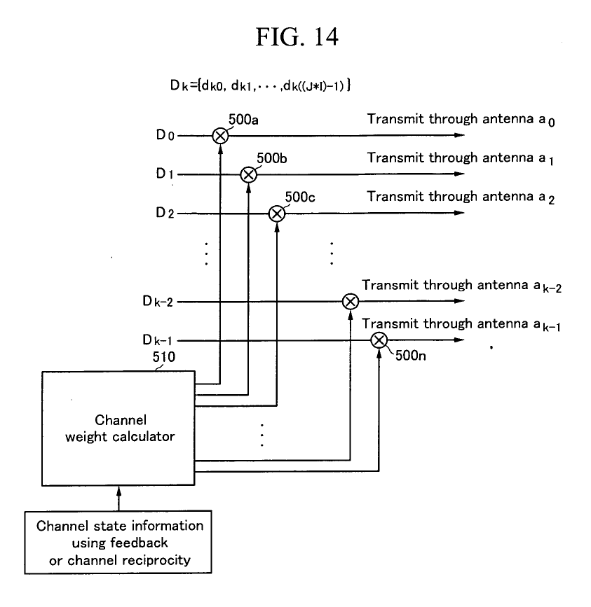

FIG. 14 shows a detailed configuration of an antenna selection controller when the method using a channel weight is used in the case that the transmit end does know a channel state.

The antenna selection controller 500 includes a channel weight calculator 510 and a plurality of multipliers 500a to 500n.

When the channel state is known by using channel feedback or change reciprocity, the antenna selection controller 500 selects a transmit antenna aₖ (which corresponds to one of 0, 1, 2, and M−1) having the best channel state for each group so as to guarantee performance in middle/low speed, and determines an average

$${w}_{k}^{{a}_{k}} = \frac{{( {h}_{k}^{{a}_{k}} )}^{*}}{\vert h \vert}$$

of a sum

$${\vert {h}_{k}^{{a}_{k}} \vert}^{2} = max ( {\vert {h}_{k}^{0} \vert}^{2} , {\vert {h}_{k}^{1} \vert}^{2} , … , {\vert {h}_{k}^{M - 1} \vert}^{2} )$$

of selected antenna power for each group and a weight of a signal to be transmitted in each group by using the channel weight calculator 510. Then the antenna selection controller 500 multiplies data to be transmitted (D₀, D₁, D₂, . . . , Dₖ₋₂, Dₖ₋₁,) by weights of signals to be transmitted for the respective groups by using the multipliers 500a to 500n and performs transmission.

The above-described exemplary embodiments of the present invention can be realized not only through a method and an apparatus, but also through a program that can perform functions corresponding to configurations of the exemplary embodiments of the present invention or a recording medium storing the program, and this can be easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to the exemplary embodiment of the present invention, an antenna is alternately selected for each allocation unit and data is transmitted through the selected transmit antenna when a transmitting end of an OFDMA system using multiple antennas does not know a channel state, and accordingly a diversity gain can be acquired without making any changes in allocation of subcarriers according to the number of antennas, a transmission structure of a pilot of the transmitting end, an allocation structure of the transmitting end, and a receiving end.

In addition, when the transmitting end does know the channel state, an antenna having the best channel state is selected for each group, and accordingly performance degradation due to feedback delay of channel state information and inter-antenna interference due to an increase of mobility of the terminal can be prevented.

What is claimed is:

1. A transmitting apparatus of an orthogonal frequency division multiplexing access (OFDMA) system using multiple antennas, the transmitting apparatus comprising:
an encoder for receiving data and modulating data or a preamble according to a desired modulation scheme;
an serial to parallel (S/P) converter for converting serial data output by the encoder to parallel data;
a preamble or pilot generator for generating a pilot or a preamble signal;
a multiplexer for multiplexing the data or preamble output by the preamble or pilot generator and the parallel data;
an antenna selection controller for dividing an entire band of a signal output from the multiplexer into groups, each formed of neighboring symbols in the time domain and neighboring subcarriers in the frequency domain, and selecting a transmit antenna for each group;
an IFFT unit for turning off subcarriers in groups selected by the antenna selection controller and subcarriers in unselected groups by the antenna selection controller and performing inverse fast Fourier transform (IFFT);
for each antenna, a parallel to serial (P/S) converter for converting parallel signals transmitted by the IFFT unit into serial signals, and inserting a cyclic prefix therein; and
for each antenna, a digital to analog (D/A) converter and filter for converting a digital signal transmitted from the P/S converter into an analog signal and filtering the analog signal, and transmitting the filtered analog signal through an antenna of an R/F end.

2. The transmitting apparatus of claim 1, wherein, when a channel state is not known, the antenna selection controller divides the entire band of the signal into groups, each formed of neighboring symbols and neighboring subcarriers, and selects a transmit antenna by sequentially performing k mod M on allocated groups and transmits the groups (where n denotes the number of groups in a symbol domain, k denotes the k-th group, and M denotes the number of transmit antennas).

3. The transmitting apparatus of claim 1, wherein, when the channel state is not known, the antenna selection controller extends an antenna selection scheme for each group to the symbol domain, and selects a transmit antenna by using (k+n) mod M and transmits the groups.

4. The transmitting apparatus of claim 1, wherein, when the channel state is not known and the antenna selection scheme for each group is extended to the symbol and frequency domains and cyclic rotation is performed on K allocated groups among P groups in the frequency domain, the antenna selection controller selects a transmit antenna by using (k′+n) mod M when k′=(k+n) mod P (where n denotes a group number in the symbol domain, and k′ denotes a number of k moved by n).

5. The transmitting apparatus of claim 4, wherein k′=(k+bₙ) mod P according to an offset bₙ for moving the k-th group by n, and the antenna selection controller determines a transmit antenna for transmitting the (n,k′)-th group by using (k′+n) mod M.

6. The transmitting apparatus of claim 1, wherein, when the channel state is known, the antenna selection controller selects a transmit antenna aₖ having the maximum channel power
$$\vert {h}_{k}^{{a}_{k}} \vert = max ( \vert {h}_{k}^{0} \vert , \vert {h}_{k}^{1} \vert , … , \vert {h}_{k}^{M - 1} \vert )$$
for the k-th group in the transmitting end among multiple transmit antennas, and performs transmission.

7. The transmitting apparatus of claim 1 or claim 6, wherein, when the channel state is known, the antenna selection controller selects an antenna aₖ having the maximum channel power for each group so as to guarantee performance in a middle and low speed environment, determines an average
$${\vert h \vert}^{2} = \frac{1}{K} {\sum }_{k = 0}^{K - 1} ( {h}_{k}^{{a}_{k}} * {( {h}_{k}^{{a}_{k}} )}^{*} )$$
of a sum
$${\vert {h}_{k}^{{a}_{k}} \vert}^{2} = max ( {\vert {h}_{k}^{0} \vert}^{2} , {\vert {h}_{k}^{1} \vert}^{2} , … , {\vert {h}_{k}^{M - 1} \vert}^{2} )$$
of a channel power of a transmit antenna selected for each group and a weight
$${w}_{k}^{{a}_{k}} = \frac{{( {h}_{k}^{{a}_{k}} )}^{*}}{\vert h \vert}$$
of a transmission signal of each group, multiplies data to be transmitted through the selected transmit antenna aₖ of each group by a weight of each transmission signal, and then transmits the multiplication result, the transmit antenna aₖ being given as one of 0, 1, 2, and M−1.

8. A transmission method of an orthogonal frequency division multiplexing access (OFDMA) system using multiple antennas, the transmission method comprising:
(a) modulating data or a preamble to be transmitted according to a predetermined modulation method;
(b) converting serially received modulated data into parallel data;
(c) generating a preamble and a pilot;
(d) multiplexing the preamble or pilot and the parallel data;
(e) dividing an entire band into groups, each formed of neighboring symbols in the time domain and neighboring subcarriers in the frequency domain, and selecting a transmit antenna for each group;
(f) for each transmit antenna, turning off subcarriers in groups selected by an antenna selection controller and subcarriers in groups unselected by the antenna selection controller and performing IFFT;
(g) for each transmit antenna, converting a parallel signal transmitted from an IFFT unit into a serial signal and inserting a cyclic prefix to the signal; and
(h) for each transmit antenna, converting and filtering a digital serial signal into an analog signal, and transmitting the analog signal through an antenna of an RF end.

9. The transmission method of claim 8, wherein, when a channel state is known, the selecting of the transmit antenna for each group comprises selecting a transmit antenna aₖ having the maximum channel power
$$\vert {h}_{k}^{{a}_{k}} \vert = max ( \vert {h}_{k}^{0} \vert , \vert {h}_{k}^{1} \vert , … , \vert {h}_{k}^{M - 1} \vert )$$
for the k-th group in a transmitting end among transmit antennas and performing transmission so as to prevent degradation of performance in an environment with high mobility and a large channel feedback delay.

10. The transmission method of claim 8 or claim 9, wherein, when a channel state is known, the selecting of the transmit antenna for each group comprises selecting an antenna aₖ having the maximum channel power for each group so as to guarantee performance in a middle and low speed environment, determining an average
$${\vert h \vert}^{2} = \frac{1}{K} {\sum }_{k = 0}^{K - 1} ( {h}_{k}^{{a}_{k}} * {( {h}_{k}^{{a}_{k}} )}^{*} )$$
of a sum
$${\vert {h}_{k}^{{a}_{k}} \vert}^{2} = max ( {\vert {h}_{k}^{0} \vert}^{2} , {\vert {h}_{k}^{1} \vert}^{2} , … , {\vert {h}_{k}^{M - 1} \vert}^{2} )$$
of a channel power of a transmit antenna selected for each group and a weight
$${w}_{k}^{{a}_{k}} = \frac{{( {h}_{k}^{{a}_{k}} )}^{*}}{\vert h \vert}$$
of a transmission signal to of each group, multiplying data to be transmitted through the transmit antenna selected for each group by the weight of each transmission signal, and transmitting the multiplication result, the transmit antenna aₖ being given as one of 0, 1, 2, and M−1.
